(19) United States
(12) Patent Application Publication
(10) Pub. No.: US 2004/0259608 A1
(43) Pub. Date: Dec. 23, 2004

(54) Folder-style mobile phone having a rotatable processing module

(76) Inventors: Cheng-Wen Huang, Taipei Hsien (TW); Shun-Yi Lien, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/462,687

(22) Filed: Jun. 17, 2003

(51) Int. Cl. H04M 1/00; H04B 1/38

(52) U.S. Cl. 455/575.3; 455/575.1

(57) ABSTRACT

A folder-style mobile phone having a rotatable processing module includes a first casing having a first hinge, a second casing having a second hinge, a processing module, and a rotatable signal-processing module. The processing module is provided in the first casing for processing data. The rotatable signal-processing module, provided in the second casing, includes a plug arranged in the second hinge to connect to a wire provided in the first hinge, an antenna for receiving and transmitting radio frequency signals, and a wireless module electrically connected between the plug and the antenna for transforming signals from the processing module into corresponding radio frequency signals to the antenna and transforming signals from the antenna into corresponding signals to the processing module.

### BACKGROUND OF INVENTION

1. Field of the Invention

The present invention relates to a folder-style mobile phone, and more specifically, to a folder-style mobile phone having a rotatable signal-processing module.

2. Description of the Prior Art

Owing to the rapid development of wireless communication systems, people can access resources, exchange information, and share experiences via a mobile phone or other wireless communication devices anytime and anywhere. In existing mobile phones, some mobile phones have two casings, one having a display and the other having buttons for manipulating the mobile phone, and a connection component therebetween, which is used as a hinge for folding the two casings.

Please refer to FIG. 1, which shows a schematic diagram of a conventional folder-style mobile phone 10. The mobile phone 10 comprises a first casing 2 and a second casing 4. The first casing 2 comprises a first hinge 6, a processing module 12, a wireless module 16, an antenna 18, a speaker 20, and a display 22. The second casing 4 comprises a second hinge 8, a processor 14, and a microphone 24. The first hinge 6 is connected with the second hinge 8 through a member in a rotatable manner, such that the first casing 2 and the second casing 4 become foldable. The processor 14 and the processing module 12 are used for processing programs and data. The antenna 18 electrically connected to the wireless module 16 is used for transceiving radio frequency (RF) signals. The wireless module 16 is electrically connected between the antenna 18 and the processing module 12 for transforming a communication signal from the processing module 12 into an RF signal and for transforming the RF signal received by the antenna 18 into corresponding signals sent to the processing module 12. Both the speaker 20 and the display 22 are electrically connected with the processing module 12 respectively for outputting audio signals and for displaying images according to data from the processing module 12. The microphone 24 is used to receive audio signals. The wire 26, which is engaged with a hole set inside the first hinge 6 and the second hinge 8, for connecting the processing module 12 and the processor 14 to exchange data.

A fatal disadvantage of assembling the first casing 2 and the second casing 4 through only a slender wire 26 is that frequently folding the first casing 2 and the second casing 4 can easily result in position offset of the wire 26, probably leading to severance of the wire 26. In another aspect, it is very complicated and time-consuming to assemble the slender wire 26 into the mobile phone in an assembly line.

### SUMMARY OF INVENTION

It is therefore a primary objective of the claimed invention to provide a folder-style mobile phone having a rotatable signal-processing module to solve the abovementioned problems.

According to the claimed invention, a folder-style mobile phone includes a first casing having a first hinge, a second casing having a second hinge, a processing module, and a rotatable signal-processing module. The processing module is provided in the first casing for processing data. The rotatable signal-processing module, provided in the second casing, includes a plug arranged in the second hinge to connect to a wire provided in the first hinge, an antenna for receiving and transmitting radio frequency signals, and a wireless module electrically connected between the plug and the antenna for transforming signals from the processing module into corresponding radio signals sent to the antenna and transforming signals from the antenna into corresponding signals sent to the processing module.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of a folder-style mobile phone according to the prior art.

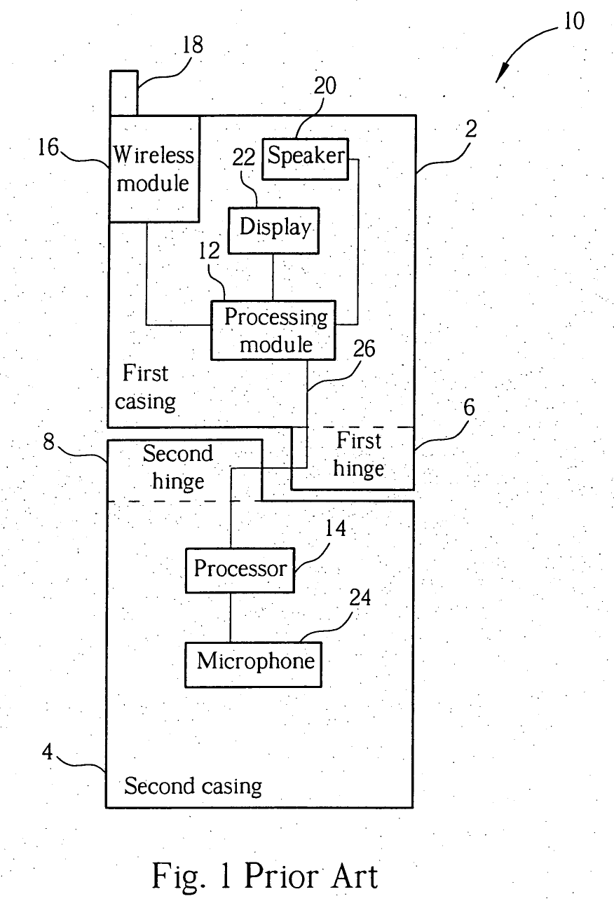

FIG. 2 is a schematic diagram of a folder-style mobile phone according to the present invention.

FIG. 3 is a top view of the folder-style mobile phone shown in FIG. 2.

### DETAILED DESCRIPTION

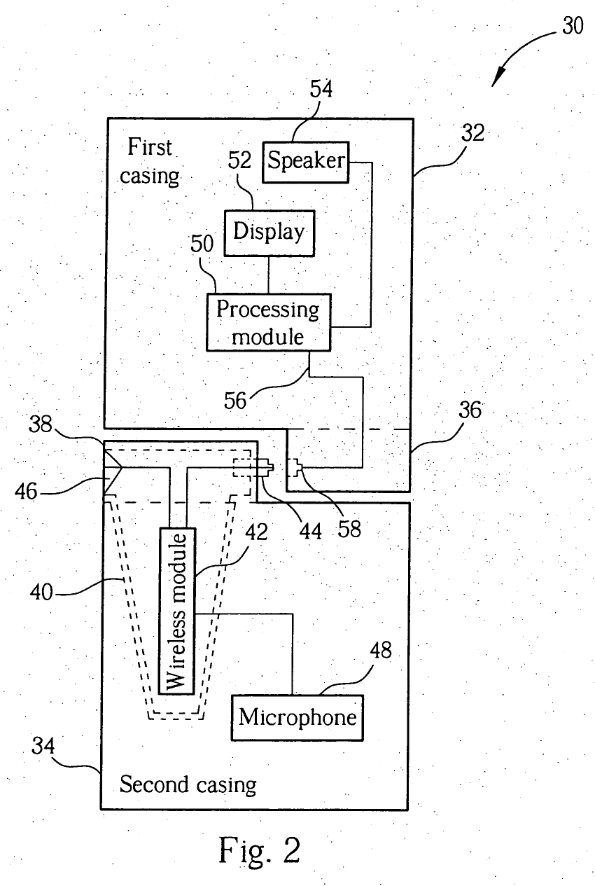

Please refer to FIG. 2. FIG. 2 is a schematic diagram of a folder-style mobile phone 30 having a rotatable signal-processing module 40 according to the present invention. The mobile phone 30 comprises a first casing 32 having a first hinge 36, a second casing 34 having a second hinge 38, a processing module 50 installed within the first casing 32 for processing data, and a signal-processing module 40 installed within the second casing 34. The signal-processing module 40 comprises a plug 44, installed within the second hinge 38, for connecting to the processing module 50 through the wire 56 of the first hinge 36, an antenna 46 which can be a hidden antenna for transceiving radio frequency signals, and a wireless module 42 electrically connected between the plug 44 and the antenna 46 for transforming signals from the processing module 50 into corresponding radio frequency signals sent to the antenna 46 and transforming signals from the antenna 46 into corresponding signals sent to the processing module 50. The mobile phone 30 further comprises a microphone 48 electrically connected to the processing module 50 for receiving and transforming an analog audio signal into a digital audio signal and delivering the digital audio signal to the processing module 50, a display 52 electrically connected to the processing module 50 for displaying image, and a speaker 54 for outputting the audio signal from the processing module 50.

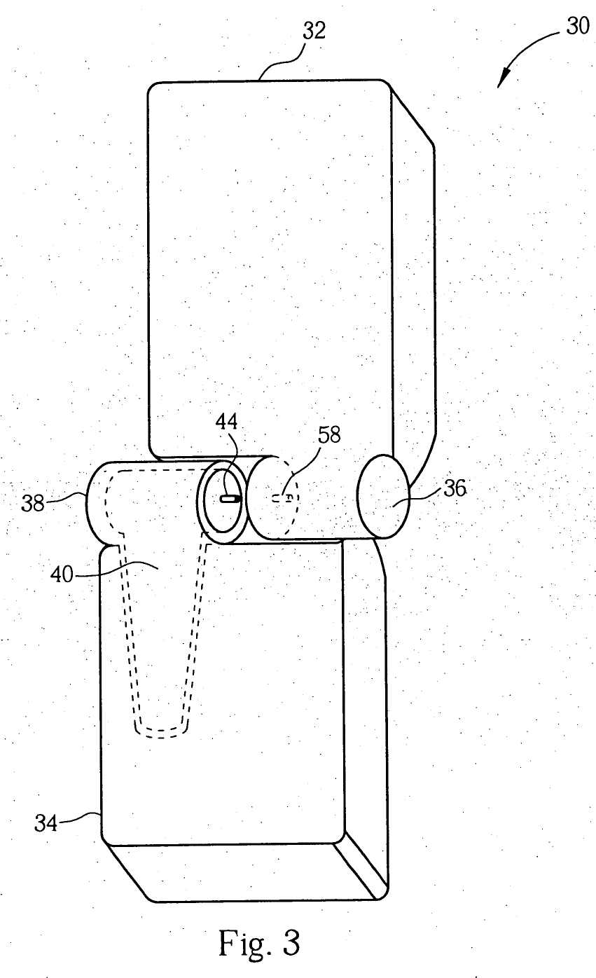

Please refer to FIG. 3 in conjunction to FIG. 2. FIG. 3 is a top view of the folder-style mobile phone 30 shown in FIG. 2. The mobile phone 30 utilizes the signal-processing module 40 with the wireless module 42 and the antenna 46 to transceive radio frequency signals. The antenna 46 and the plug 44 are installed within the second hinge 38 of the second casing 34, where the plug 44 is extended out of the second hinge 38 for electrically connecting with the wire 56 installed within the first hinge 36, or for electrically connecting with an outlet 58 set within the first hinge 36. The outlet 58 via the wire 56, electrically connected to the processing module 50, is used for engaging with the plug 44. Basically, any assembling device and related method for achieving the purpose of electrical-connection, like the plug 44, belongs to the scope of the present invention.

Within the mobile phone 30, both the antenna 46 and the plug 44 of the signal-processing module 40 are positioned in the second hinge 38 of the second casing 34. When the first casing 32 and the second casing 34 are folded, i.e., the first hinge 36 is rotated relative to the second hinge 38, the signal-processing module 40, fixed in the second casing 34 and the second hinge 38 thereof, does not cause position offset of the wire located in the first hinge 36. Accordingly, electrical components and function modules configured within the first casing 32 are electrically connected with those configured within the second casing 34 by means of the outlet 58 and the plug 56, rather than a conventional slender wire, preventing a severance of the wire from malfunction of the mobile phone 30.

In contrast to prior art, the present invention folder-style mobile phone comprises a signal-processing module having an antenna, a plug and a wireless module installed within the second casing, where the plug is extended out of the second hinge of the second casing. When the first casing and the second casing are folded, due to the first hinge rotating in relative to the second hinge in which both the antenna and the plug of the signal-processing module are fixed, the wire located in the first hinge and the second hinge can not be easily severed or damaged by external force. On the other hand, the way of utilizing the plug and the outlet to connect the first casing and the second casing can reduce assembling time in comparison with using the wire directly. As a result, the present invention folder-style mobile phone has better durability and less assembly time.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A folder-style mobile phone comprising:
a first casing having a first hinge;
a second casing having a second hinge;
a processing module installed within the first casing for processing data; and
a signal-processing module installed within the second casing comprising:
a plug installed within the second hinge connected to the processing module via a wire located in the first hinge;
an antenna for transceiving an RF signal; and
a wireless module electrically connected to the plug and the antenna for transforming a communication signal from the processing module into the RF signal and for transforming the RF signal received by the antenna into the communication signal.

2. The folder-style mobile phone of claim 1 wherein the antenna is a hidden antenna.

3. The folder-style mobile phone of claim 1 further comprising a microphone electrically to the processing module for receiving and transforming an analog audio signal into a digital audio signal, and then delivering the digital audio signal to the processing module.

4. The folder-style mobile phone of claim 1 further comprising a display electrically connected to the processing module for displaying images.

5. The folder-style mobile phone of claim 1 further comprising a speaker electrically connected to the processing module for outputting an audio signal from the processing module.

6. The folder-style mobile phone of claim 1 further comprising an outlet installed within the first hinge for connecting the plug.
